(19) United States
(12) Patent Application Publication
(10) Pub. No.: US 2015/0345562 A1
(43) Pub. Date: Dec. 3, 2015

(54) ROLLING BEARING WITH SEALING SUBASSEMBLY

(71) Applicant: AKTIEBOLAGET SKF, Goteborg (SE)

(72) Inventors: Laurent VARNOUX, Saint-avertin (FR); Jean-Marie GERARD, Joue-les-tours (FR)

(21) Appl. No.: 14/436,558

(22) PCT Filed: Oct. 19, 2012
(86) PCT No.: PCT/EP2012/070742

§ 371 Date: Apr. 17, 2015

(51) Int. Cl. F16C 33/78; F16C 19/06

(52) U.S. Cl. CPC F16C 33/7859; F16C 19/06; F16C 33/7896

(57) ABSTRACT

A rolling bearing comprising an inner ring, an outer ring, at least one row of rolling elements disposed between the rings and at least one sealing subassembly mounted on one of the rings. One of the rings includes a shield disposed in axial contact with the ring and extending towards the other ring. A sealing element is fixed onto the shield and coming into friction contact against the ring.

### CROSS REFERENCE TO RELATED APPLICATIONS

This is a United States National Stage Application claiming the benefit of International Application Number PCT/EP2012/070742 filed on 19 Oct. 2012, which is incorporated herein by reference in its entirety.

### FIELD OF THE INVENTION

The present invention relates to rolling bearings.

### PRIOR ART

In a rolling bearing, one or more seals or sealing devices are generally used to keep the lubricant, such as grease, inside the bearing and to prevent ingress of foreign matter. Generally, such seals or sealing devices are attached to one of the rings and cooperate with the other ring.

International patent application WO-A1-2011/121385 (SKF) discloses a rolling bearing comprising an inner ring, an outer ring and two sealing devices to close the radial space existing between the rings. Each sealing device comprises a seal radially disposed between the rings and an annular shield fixed to the inner ring and arranged laterally to the seal so as to define a gap therebetween. The shield comprises a radial portion in axial contact with a radial surface of the inner ring which is extended by a bended inner portion arranged inside an annular groove made in the bore of said ring.

With such a sealing device, some foreign pollutant particles, such as dust or muddy mater, may pass through the space(s) existing between the inner portion of the shield and the groove of the inner ring. As a matter on fact, the shield is formed from a metal sheet by folding, cutting and stamping. Besides, the inner portion of said shield is press-fitted into the groove. Consequently, the inner portion of the shield is not perfectly straight with a good planarity and some radial narrow passageways may be formed between the exterior surface of said inner portion and the groove of the inner ring.

### OBJECT AND BRIEF SUMMARY OF THE INVENTION

One aim of the present invention is to overcome this drawback.

It is a particular object of the present invention to provide a rolling bearing which is simple to manufacture and to assembly while guaranteeing good sealing properties.

In one embodiment, the rolling bearing comprises an inner ring, an outer ring, at least one row of rolling elements disposed between the rings and at least one sealing subassembly mounted on one of the rings and provided with a shield disposed in axial contact with said ring and extending towards the other ring, and with a sealing element fixed onto the shield and coming into friction contact against said ring.

The sealing element may bear at least radially against said ring.

Preferably, the relative diameters of the sealing element and said ring in a free state are adapted so as to create a permanent interference fit therebetween.

In one embodiment, the shield is formed of a rigid material and the sealing element is formed of a flexible material.

The surface of the sealing element bearing against said ring may have a complementary shape with respect to the associated surface of said ring. The sealing element may comprise a lip bearing against said ring.

In one embodiment, the sealing element bears against a groove made onto said ring. Preferably, the groove extends obliquely towards the outside.

Preferably, the shield comprises a radial portion in axial contact with a frontal surface of said ring.

In one embodiment, the shield may further comprise an axial portion extending from the radial portion axially towards said ring. Advantageously, the sealing element may be radially disposed between the axial portion of the shield and said ring. The surface of the sealing element bearing against the axial portion of the shield may have a complementary shape with respect to the associated surface of said axial portion.

In another embodiment, the shield only comprises the radial portion. The sealing element may be fixed at a free edge of the radial portion.

In one embodiment, the rolling bearing further comprises an additional seal mounted on the other ring and which applies a dynamic sealing with said ring. The additional seal may comprise at least one sealing lip bearing against the shield. Alternatively or in combination, the shield may comprise at least one sealing lip bearing against the additional seal.

In one embodiment, the sealing subassembly is mounted on the inner ring. Alternatively, said subassembly may be mounted on the outer ring.

### BRIEF DESCRIPTION OF THE DRAWINGS

The present invention and its advantages will be better understood by studying the detailed description of specific embodiments given by way of non-limiting examples and illustrated by the appended drawings in which:

FIG. 1 shows an axial half-section of a rolling bearing according to a first example of the invention;

FIG. 2 shows an axial half-section of a rolling bearing according to a second example of the invention; and

FIG. 3 shows an axial half-section of a rolling bearing according to a third example of the invention.

### DETAILED DESCRIPTION OF PARTICULAR EMBODIMENTS

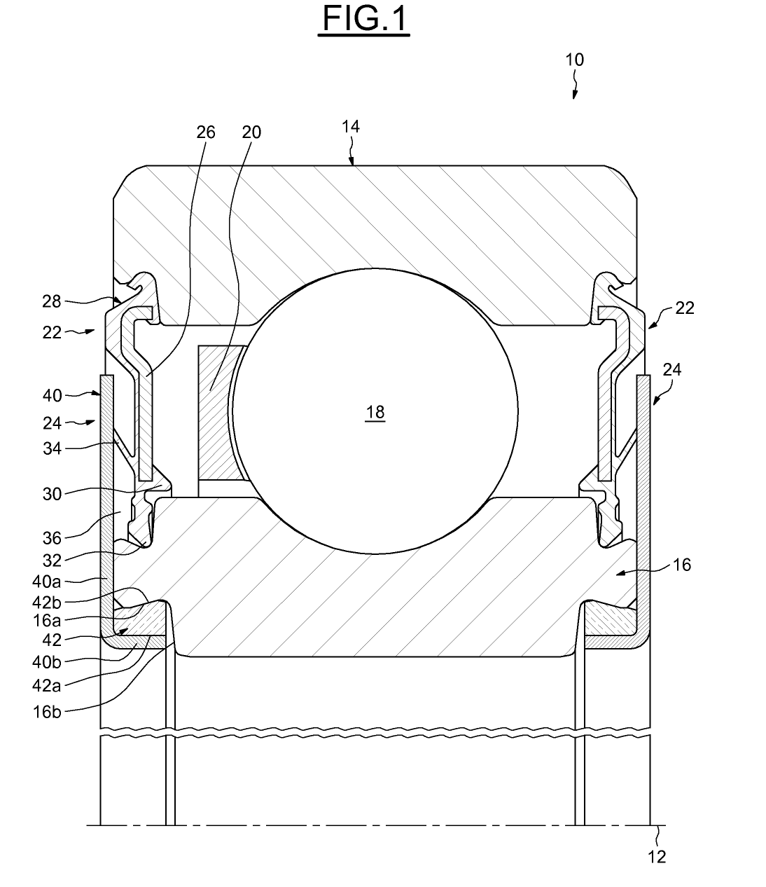

As illustrated on FIG. 1, which illustrates an embodiment of a rolling bearing 10 according to a first example of the invention, said rolling bearing, with an axis 12, comprises an outer ring 14, an inner ring 16, a plurality of rolling elements 18, which in this case are balls, interposed between the rings, and a cage 20 for maintaining said rolling elements circumferentially spaced apart. The rolling bearing 10 further comprises on each side an annular seal 22 and an annular sealing subassembly 24 to close the radial space that exists between the rings 14, 16.

The inner and outer rings 14, 16 are concentric and symmetric with respect to the transverse radial plane passing through the centre of the rolling bearing 10. The rings are of the solid type. One of the rings rotates while the other is fixed or also rotates. The outer ring 14 comprises a toroidal circular raceway formed onto its bore and two annular recesses or grooves formed radially towards the outside from the bore and arranged laterally to the raceway. Similarly, the inner ring 16 comprises a toroidal circular raceway formed onto its exterior axial surface and two annular recesses or grooves formed radially towards the inside from the exterior surface and arranged laterally to the raceway.

Each seal 22 is arranged radially between the outer and inner rings 14 and 16, fixed to said outer ring and arranged laterally to the rolling elements 18. Each seal 22 is provided with a rigid insert or core member 26 made of metal or thermoplastic and with an elastic sealing member 28 made of rubber, synthetic resin, polymer or the like, which partially covers the core member 26.

The sealing member 28 covers an outer surface of the core member 26 and forms two radially opposed peripheral sealing portions applying respectively a static sealing with the outer ring 14 and a dynamic sealing with the inner ring 16. “Static sealing” means the sealing made between two parts that do not move relative to one another. “Dynamic sealing” means the sealing made between two parts that move relative to one another. The outer sealing portion of the elastic member 28 is press-fitted in the groove of the outer ring 14 in order to attach the seal 22 to said ring.

The inner sealing portion of the elastic member 28 is provided with first and second inner sealing lips 30 and 32, which are concentric with each other and which extend axially inwards. The second lip 32 bears against the groove made on the exterior surface of the inner ring. The first lip 30 has a larger diameter than the second lip 32 and extends axially inward over the exterior surface of the inner ring 16 to form therebetween a labyrinth seal. The inner sealing portion further comprises an outer sealing lip 34 extending towards the outside of the rolling bearing 10 and bearing against an inner surface of the sealing subassembly 24 to create a sealed axial chamber 36 between the seal 26 and said sealing subassembly. The chamber may define a tank for grease. The outer lip 34 is axially offset towards the outside relative to the inner lips 30, 32.

Each sealing subassembly 24 comprises a shield 40 coupled to the inner ring 16 and a sealing element 42 fixed to the shield and bearing against said ring. The shield 40 has an annular cup form and is arranged laterally to the inner seal 22 and spaced apart from said seal. The axial chamber 36 is formed between the outer shield 40 and the inner seal 22. The shield 40 is formed from a rigid material. The shield 40 may be formed for example from a metal steel sheet by folding, cutting and stamping. The shield 40 may also be formed from another metallic material such as copper or aluminium or from an alloy such as brass. Alternatively, the shield 40 may also be made from plastic material by moulding, for example in polyamide (PA).

The shield 40 extends radially towards the outer ring 14 and has an inner surface facing towards an opposing outer surface of the seal 22 and coming into axial direct contact with the inner ring 16. The shield 40 comprises an annular radial portion 40a which is arranged in axial direct contact with the radial transverse frontal surface of the inner ring 16, and an inner annular axial portion 40b extending axially inwards from a small-diameter edge of said radial portion. The outer free edge of the radial portion 40a defines with the seal 22 a labyrinth passage in order to reduce the intrusion of contaminants. The lip 34 of the seal bears against the inner face of the radial portion 40a, said face coming into contact with the frontal surface of the inner ring.

The inner axial portion 40b of the shield extends axially into the bore of the inner ring and remains at a distance from said bore. There is no contact between the axial portion 40b and the inner ring. The axial portion 40b extends into an annular groove 16a made in the bore of the inner ring 16. A radial gap is defined between the axial portion 40b and the groove 16a. The groove 16a has a frustoconical form and extends obliquely downwards and outwards from a radial wall 16b of the inner ring delimiting axially said groove. In the disclosed embodiment, the free end of the axial portion 40b of the shield remains at a distance from the radial wall 16b.

The sealing element 42 is formed of a flexible synthetic material, for example made of nitrile, polyamide, polytetrafluoroethylene or elastomere such as synthetic rubber. Advantageously, the sealing element 42 may be overmoulded over the shield 40 by overmoulding or even by bi-injection. Alternatively, the sealing element 42 may be fixed onto the shield by any appropriate means, for example by gluing, vulcanization, clipping etc.

The sealing element 42 is rigidly fixed to the inner portion 40b of the shield and radially disposed between said inner portion and the inner ring 16. The sealing element 42 has an annular form and is delimited axially by a first radial surface bearing against the inner face of the radial portion 40a of the shield and a second opposite radial surface facing the radial wall 16b of the inner ring. Here, the second radial surface of the sealing element 42 remains axially distant from the radial wall 16b. Alternatively, said radial surface may bear against the wall 16b. The sealing element 42 is delimited radially by an annular bore 42a mounted on the exterior surface of the axial portion 40b of the shield and an exterior surface 42b coming into friction contact against the groove 16a of the inner ring. If the sealing element 42 is overmoulded on the shield 40, the inner axial portion 40b of said shield may comprise a plurality of through holes allowing the material to pass through during the overmoulding in order to obtain radial ribs extending from the bore 42a of the sealing element, thereby ensuring good material fastening of these two elements.

The exterior surface 42b of the sealing element has a complementary shape with respect to the groove 16a of the inner ring. Said exterior surface has a frustoconical form. The sealing subassembly 24 is fastened with the inner ring due to the friction contact forces between the exterior surface 42b of the sealing element and the groove 16a of the inner ring. The diameter of said exterior surface 42b in a free state is greater than the diameter of the groove 16a in order to have a permanent interference fit between the sealing element 42 and the inner ring 16. This surely prevents a rotation and a translation of the sealing subassembly 24 relative to the inner ring 16. The sealing element 42 forms retaining or anchorage means bearing radially against the inner ring 16 to fix or attach the sealing subassembly 24 to said ring both in the axial and circumferential directions. Otherwise, the interference fit between the sealing element 42 and the inner ring 16 enhances the efficiency of the static sealing between these two elements.

The sealing element 42 is mounted on the inner ring 16 by force-fitting, for example by axial snapping or pressing to sealingly attach the shield 40 to said ring. At the groove 16a, the sealing element 42 matches the shape of the groove 16a of the inner ring. The sealing element 42 surrounds the inner axial portion 40b of the shield so that only said elastic sealing element is in contact with the bore of the inner ring 16. The sealing element 42 is radially interposed between the shield 40 and the inner ring 16.

During the assembly of the sealing element 42 into the bore of the inner ring, said inner ring exerts a radial compression force on the sealing element. In return of the radial compression force exerted, the sealing element 42 exerts a permanent radial force on the inner ring 16 tending to keep said element in radial contact with the groove 16a of said ring. The intrusion of foreign matter between the sealing element 42 and the inner ring 16 is thus prevented.

Otherwise, during the assembly of the sealing subassembly 24 on the inner ring, the sealing element 42 may also be compressed to compensate manufacturing defects or large tolerances of the inner ring which can lead to some radial narrow passageways between the inner ring and the shield when said shield is mounted on said ring without interposition of the sealing element.

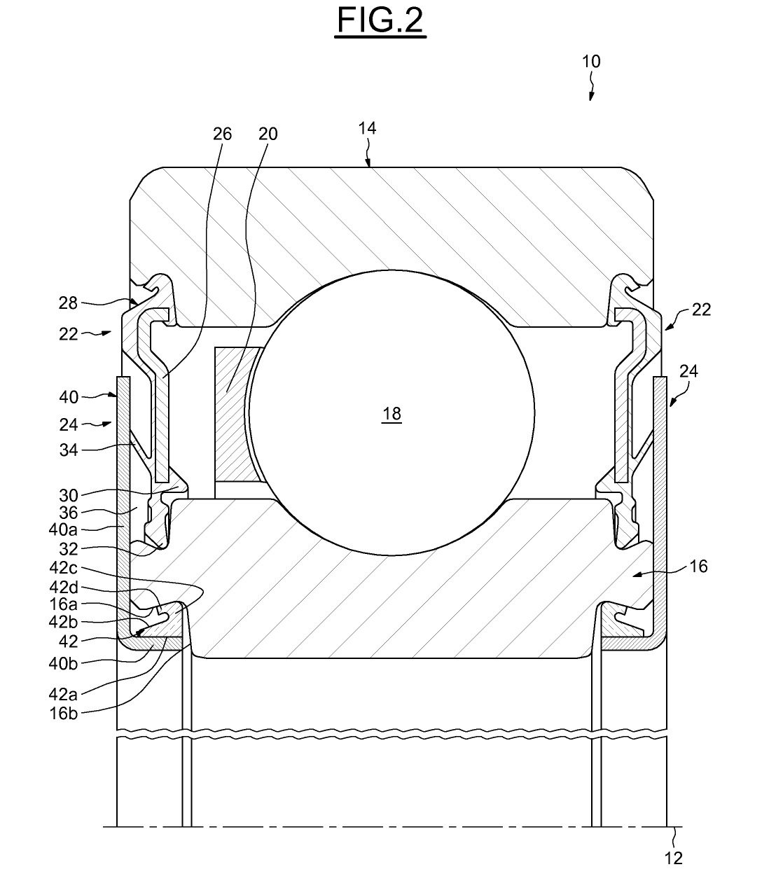

The embodiment shown on FIG. 2, in which identical parts are given identical references, differs from the previous embodiment in that the sealing element 42 comprises an annular radial heel 42c extending from the exterior surface 42b of said element and an annular lip 42d extending from said heel. The lip 42d extends obliquely outwards and upwards from the heel 42c and comes into permanent friction contact with the groove 16a of the inner ring. The lip 42d extends radially outwards and axially upwards in the direction of the bore of the inner ring 16 and bears against this bore. The diameter of the lip 42d in a free state is greater than the diameter of the groove 16a of the inner ring in order to have a permanent interference fit between the sealing element 42 and the inner ring 16.

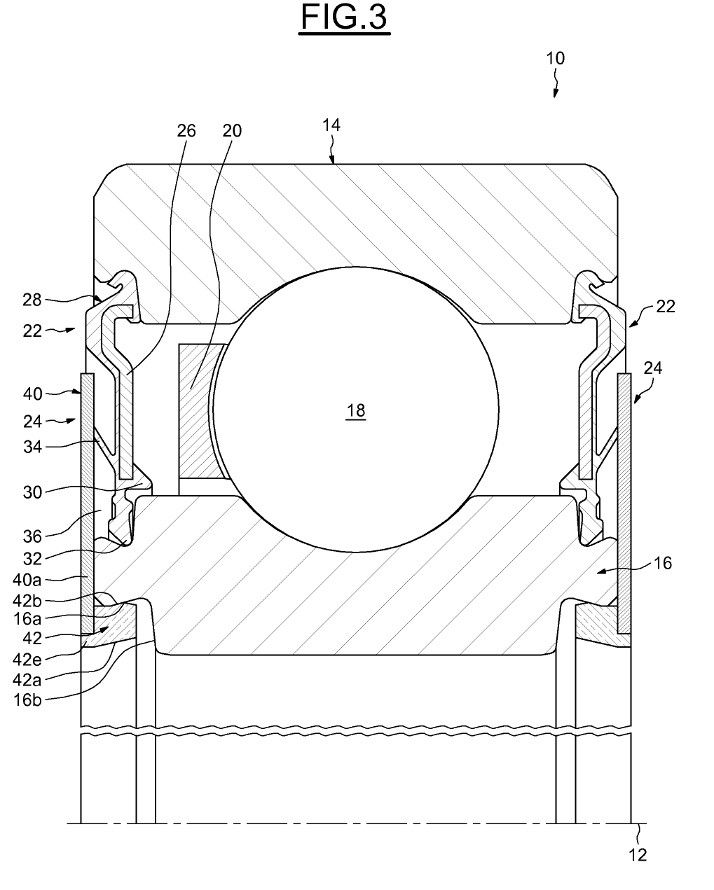

The embodiment shown on FIG. 3, in which identical parts are given identical references, differs from the first embodiment in that the shield 40 only comprises the radial portion 40a, the sealing element 42 being fixed into the bore of the small-diameter free edge of the radial portion. The diameter of the exterior surface 42b of the sealing element in a free state is greater than the diameter of the groove 16a in order to have a permanent interference fit between the sealing element and the inner ring 16. In this embodiment, the sealing element 42 comprises an annular axial extension 42a mounted into the small-diameter free edge of the radial portion 40a of the shield and extending axially outwards the bore of said sealing element.

In the disclosed embodiments, the sealing element is mounted into a frustoconical groove of the bore of the inner ring. Alternatively, it could be possible to mount said sealing element into a cylindrical groove of the inner ring or into the cylindrical bore of said ring deprived of groove. In the described embodiments, the sealing subassembly 24 is fixed on the inner ring 16. Alternatively, it might be possible to fix the subassembly on the outer ring. In this case, the sealing element bears against the exterior surface of the outer ring and the shield axially comes into contact with the frontal surface of said outer ring.

In another embodiment, it could also be possible to foresee, alternatively or in combination of the lip 34, a lip on the radial portion 40a of the shield which bears against the sealing member 28 of the seal. In another embodiment, it could be possible to not use an additional seal 22 and to foresee a cooperation between the free edge of the radial portion 40a of the shield and the associated ring to form a labyrinth passage.

The sealing element rigidly coupled to the shield enables to obtain a unitary sealing subassembly. The specific structure of the sealing element having a circumferentially continuous surface in friction contact with the associated ring permits to obtain a sealing subassembly particularly easy to mount on the rolling bearing with a simple axial pushing movement without angular orientation. Besides, with such a sealing element, the sealing subassembly has an improved static sealing with the associated ring due to the contact over 360°. Otherwise, the sealing element enables to compensate for possible manufacturing defects, large tolerances or assembly constraints.

1. A rolling bearing comprising an inner ring, an outer ring and at least one row of rolling elements disposed between the rings; and
at least one sealing subassembly mounted on one of the inner ring or the outer ring and provided with a shield disposed in axial contact with the one of the inner ring or the outer ring and extending towards the other of the inner ring or the outer ring, and with a sealing element fixed onto the shield and coming into friction contact against the one of the inner ring or the outer ring.

2. The rolling bearing according to claim 1, wherein the sealing element bears at least radially against the one of the inner ring or the outer ring.

3. The rolling bearing according to claim 1, wherein the relative diameters of the sealing element and the one of the inner ring or the outer ring in a free state are adapted so as to create a permanent interference fit therebetween.

4. The rolling bearing according to claim 1, wherein the shield is formed of a rigid material and the sealing element is formed of a flexible material.

5. The rolling bearing according to claim 1, wherein the surface of the sealing element bearing against the one of the inner ring or the outer ring has a complementary shape with respect to the associated surface of the one of the inner ring or the outer ring.

6. The rolling bearing according to claim 1, wherein the sealing element comprises a lip bearing against the one of the inner ring or the outer ring.

7. The rolling bearing according to claim 1, wherein the sealing element bears against a groove made onto the one of the inner ring or the outer ring.

8. The rolling bearing according to claim 7, wherein the groove extends obliquely towards the outside.

9. The rolling bearing according to claim 1, wherein the shield comprises a radial portion in axial contact with a frontal surface of the one of the inner ring or the outer ring.

10. The rolling bearing according to claim 9, wherein the shield further comprises an axial portion extending from the radial portion axially towards the one of the inner ring or the outer ring.

11. The rolling bearing according to claim 10, wherein the sealing element is radially disposed between the axial portion of the shield and the one of the inner ring or the outer ring.

12. The rolling bearing according to claim 10, wherein the surface of the sealing element bearing against the axial portion of the shield has a complementary shape with respect to the associated surface of the axial portion.

13. The rolling bearing according to claim 9, wherein the sealing element is fixed at a free edge of the radial portion of the shield.

14. The rolling bearing according to claim 1, further comprising an additional seal mounted on the other ring and which applies a dynamic sealing with the one of the inner ring or the outer ring.

15. The rolling bearing according to claim 14, wherein the additional seal comprises at least one sealing lip bearing against the shield.

16. The rolling bearing according to claim 14, wherein the shield comprises at least one sealing lip bearing against the additional seal.
